(19) United States
(12) Patent Application Publication
(10) Pub. No.: US 2011/0098409 A1
(43) Pub. Date: Apr. 28, 2011

(54) COMPOSITIONS AND ARTICLES FOR HIGH-TEMPERATURE WEAR USE

(75) Inventors: Robert Ray Burch, Exton, PA (US); Jesus G. Moralez, Wilmington, DE (US); Shekhar Subramoney, Hockessin, DE (US); Susan H. Tilford, Ewing, NJ (US)

(73) Assignee: E.I. DU PONT DE NEMOURS AND COMPANY, Wilmington, DE (US)

(21) Appl. No.: 12/912,188

(22) Filed: Oct. 26, 2010

Related U.S. Application Data
(60) Provisional application No. 61/255,295, filed on Oct. 27, 2009.
(60) Provisional application No. 61/255,145, filed on Oct. 27, 2009.
(60) Provisional application No. 61/255,346, filed on Oct. 27, 2009.
(60) Provisional application No. 61/255,147, filed on Oct. 27, 2009.

(51) Int. Cl. C08L 79/08

(52) U.S. Cl. 524/600

(57) ABSTRACT

Disclosed herein are compositions and articles that are useful in environments exposed to heat, wear, and oxidizing agents, which are improved by means of specific kinds of carbon filaments. The compositions and articles comprise high-temperature polymer, high-temperature filler, and a mixture of carbon filament, wherein said mixture of carbon filament comprises multiwall axial carbon filament.

### CROSS REFERENCE TO RELATED APPLICATIONS

This application claims the benefit of U.S. Provisional Application 61/255,295 filed Oct. 27, 2009; U.S. Provisional Application 61/255,145 filed Oct. 27, 2009; U.S. Provisional Application 61/255,346 filed Oct. 27, 2009; U.S. Provisional Application 61/255,147 filed Oct. 27, 2009.

### BACKGROUND OF THE INVENTION

1. Field of the Invention

This disclosure relates to compositions and articles resistant to wear at ambient and high temperature.

2. Description of the Related Art

Multicomponent compositions are used in applications subject to stress, wear and eventual replacement (for example, bearings and rotating shafts). Certain such compositions preferably maintain combinations of strength and long life under wear at both ambient and high temperatures, such as in aircraft and automobile engine areas, or in an oxidizing atmosphere such as air, or both.

The following disclosures may be relevant to various aspects of the present invention and may be briefly summarized as follows:

U.S. Pat. No. 5,312,866 to Tsutsumi et al. discloses a molding resin composition comprising 99.9 to 50% by weight of polyimide material and 0.1 to 50% by weight of PEK (polyether ketone) resin and/or polyester resin, and more particularly comprising the polyester resin capable of forming an anistropical molten phase at a temperature of 420° C. or less and a polyimide-based molding resin composition which comprises the said resins and other additives such as phenolic resin, fluororesin, graphite, carbon fibers, aromatic polyamide fibers, potassium titanate fibers and a crystallization accelerator, and is excellent in thermal resistance, chemical resistance, mechanical strength and processability.

U.S. Pat. No. 5,886,129 to DeColibus, issued Mar. 23, 1999, entitled “Oxidatively stable rigid aromatic polyimide compositions and process for their preparation,” describes certain polyimide polymers, and certain fillers which may be used with these polyimides.

There remains an ongoing need for compositions and articles with combinations of strength and long life under wear at both ambient and high temperatures, such as in aircraft and automobile engine areas, or in an oxidizing atmosphere such as air, or both.

### BRIEF SUMMARY OF THE INVENTION

The invention relates to compositions and articles suitable for use in environments exposed to heat, wear, and oxidizing agents, improved by means of specific kinds of carbon filaments. The compositions and articles comprise (a) from about 20 weight percent to about 55 weight percent of high-temperature polymer, and (b) from about 35 weight percent to about 55 weight percent of high-temperature filler, and (c) from about 0.1 weight percent to about 10 weight percent of a mixture of carbon filament; wherein the total of weight percent of said composition equals 100, and wherein said mixture of carbon filament comprises multiwall axial carbon filament.

### BRIEF DESCRIPTION OF THE SEVERAL VIEWS OF THE DRAWING(S)

FIG. 1 of the known art is a computer graphic showing uppermost a hexagonal graphene layer as a tapered tube, and below a stack of about 16 of such tubes.

FIG. 2 of the known art is a schematic view of a partial cut-away of a stack of eight tapered tubes.

FIG. 3 of the known art is a schematic view of three areas of film of carbon over the outer surface of a stack as in FIG. 2.

FIG. 4 of the known art shows a schematic view of a section of a concentric multiwall carbon nanotube.

FIG. 5 of the known art shows a schematic view of a section of a spiral-wrapped multiwall carbon nanotube.

FIG. 6 of the known art is a schematic drawing of stages of catalyst producing carbon filament types.

FIG. 7 is a transmission electron microscope image of carbon filaments CF-A.

FIG. 8 is a higher magnification transmission electron microscope image of carbon filaments CF-A.

FIG. 9 is a yet higher magnification transmission electron microscope image of carbon filaments CF-A.

FIG. 10 is a transmission electron microscope image of mixture CF-CN showing carbon filaments and an iron particle.

FIG. 11 is a lower magnification transmission electron microscope image of mixture CF-CN showing carbon filaments.

FIG. 12 is a higher magnification transmission electron microscope image of mixture CF-CN showing the structure of a filament.

FIG. 13 is a transmission electron microscope image of mixture CF-CP.

FIG. 14 is a higher magnification transmission electron microscope image of a portion of one filament of CF-CP.

FIG. 15 is a medium magnification transmission electron micrograph of a portion of another filament of CF-CP.

FIGS. 16 A-D illustrate Raman spectra.

FIG. 17 is a schematic of a portion of an apparatus for measuring wear using a vibratory/oscillatory test method.

### DETAILED DESCRIPTION OF THE INVENTION

The invention relates to compositions and articles suitable for use in environments exposed to heat, temperature changes, wear (e.g. frictional loss of mass), oxidizing agents, other stresses, or combinations thereof. Such compositions and articles are improved herein by means of addition of specific kinds of carbon filaments. The compositions and articles also include polymer(s) and filler(s). The articles may include a bearing or bushing, which may be used in a heated and cooled environment. Examples of such uses include: an automotive or aircraft engine compartment or an oil well, subjected to reciprocating or oscillatory or vibratory wear, or exposed to an oxidizing environment such as air or oxygen, or subjected to tensile stress or shear stress, or combinations thereof.

Deterioration of compositions or articles in such environments can proceed through chemical or physical changes. Failure can be gradual and necessitate costly preventative maintenance or replacement (e.g. failure or risk of failure by erosion of the composition or degraded composition of the article), or catastrophic (e.g. by loss of strength of the degraded or eroded article causing sudden, possibly irreparable loss of function). Disclosed herein is a composition comprising from about 20 weight percent to about 55 weight percent of high-temperature polymer, and from about 35 weight percent to about 55 weight percent of high-temperature filler, and from about 0.1 weight percent to about 10 weight percent of a mixture of carbon filament; wherein the total of weight percent of said composition equals 100, and wherein said carbon filament comprises a multiwall axial carbon filament.

The carbon filament in a composition hereof is an elongated carbon structure that is relatively long in relation to its diameter, and a filament thus may have an aspect ratio (length divided by diameter) that is greater than about 10, or 100, or 10,000, or even about 1,000,000, and yet less than 1,000,000,000. The diameter referred to in the aspect ratio is the outside diameter of the filament since the filament may, in certain embodiments, be tubular in shape and thus also have an inside diameter that describes the size of a bore, such as an annular opening, in the interior of the filament. The bore may be devoid of carbon and/or may be empty or evacuable, or the bore may contain carbon bridges therein. In other embodiments, however, the filament does not to any significant extent have a bore or interior annular opening.

Although most carbon filaments are relatively regular in shape and nearly constant in diameter, a stated diameter value for a filament, whether inside or outside diameter, is nevertheless an average diameter value determined for a selected length of the filament. The outside diameter of a carbon filament as used herein may be greater than about 1 nm, or 5 nm, 10 nm, 100 nm, and yet less than about 500 nm.

For those carbon filaments that have a bore, the interior diameter of a filament as used herein may be greater than about 1 nm, or 5 nm, 10 nm, or greater than about 50 nm, and yet be less than about 300 nm. The ratio of diameters of the hollow bore to the filament having the hollow bore can be less than 0.5, preferably less that 0.4, 0.3, 0.2, or 0.1.

The cross section of a carbon filament may form a shape that is cylindrical, or essentially cylindrical, or a shape that is polyhedral. Filaments having an outside diameter in the smaller size ranges, such as about 1 nm to about 20 nm, or about 1 nm to about 10 nm, or about 1 nm to about 5 nm, have a shape that is nearly truly cylindrical and thus have a cross section that is nearly truly circular.

Carbon filaments suitable for use herein may be prepared by various known processes such as vapor deposition or laser ablation of a carbon target. Vapor grown filaments may be made by thermal decomposition of an organic compound, particularly a hydrocarbon gas, such as benzene, toluene, or xylene, in the presence of a transition metal catalyst. The filaments are obtained by the formation around a catalyst element of one or more graphene layers that may have a variety of different geometries and orientations to each other. Suitable catalysts include nickel and iron. When more than one graphene layer is present, they are often arranged in a regularly repeating pattern.

In a carbon filament as used herein the graphitic carbon atoms may have variety of arrangement including one or a combination of agglomerations, crystals, layers, concentric layers, scrolled layers, tree-like structures, or hollow structures.

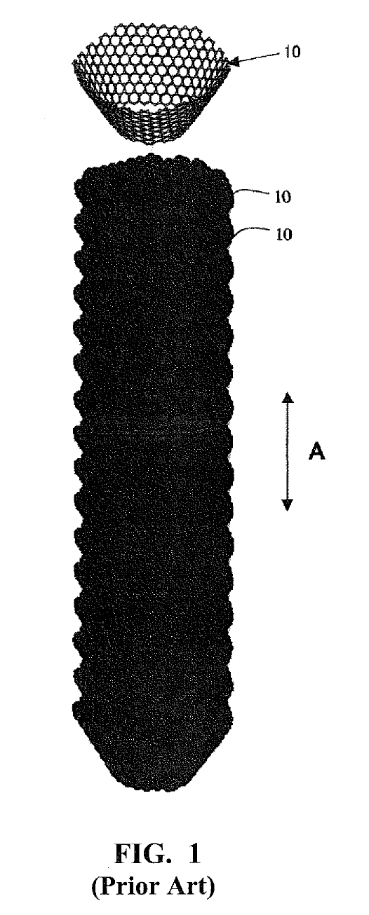

The graphene sheets may lie at an angle to the axis and thus flare out from the axis of the filament in an orientation referred to as angled. The graphene sheets in this arrangement appear to form stacked cups or inverted lampshades, and this is shown in FIGS. 1-3.

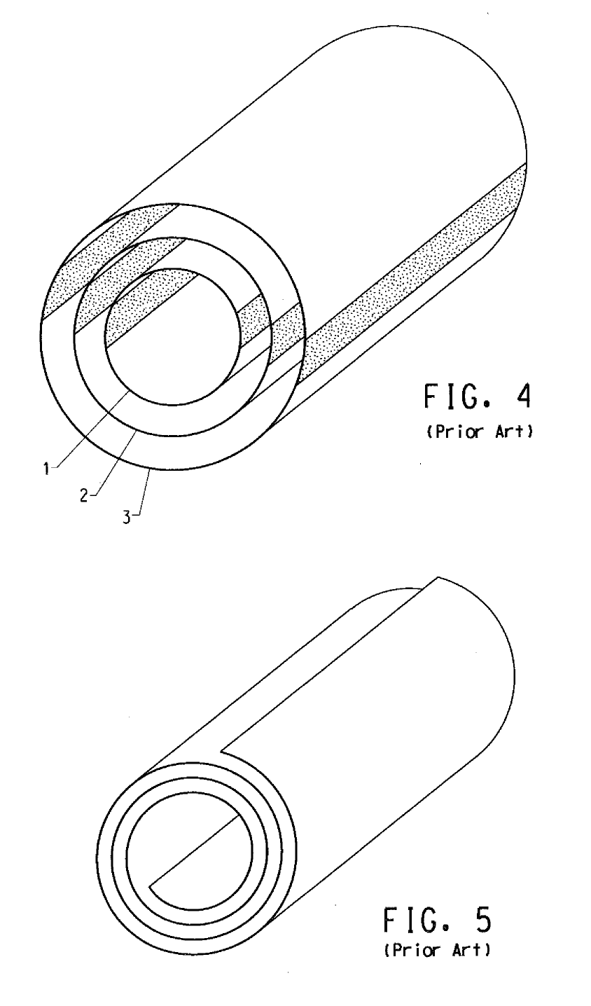

The graphene sheets, in what is known as an axial arrangement, may lie parallel to or essentially parallel to the axis of the filament, and when viewed in cross section, will appear to be circular or essentially circular. This type of arrangement is shown in FIGS. 4 and 5.

The carbon filaments suitable for use herein include those structures that are sometimes referred to as carbon fibrils, fine carbon fibers or carbon nanofibers, any one of which may actually be a bundle of individual filaments. These carbon structures may typically have an outside diameter in the range of about 50 nm to about 300 nm, or in the range of about 100 nm to about 250 nm. The carbon filaments suitable for use herein also include those structures that are sometimes referred to as carbon nanotubes, which may be single-wall nanotubes, or multiwall nanotubes, or multiwall axial carbon filaments. Single wall carbon filaments typically have an outside diameter in the range of about 1 nm to about 5 nm; and multiwall axial carbon filaments may typically have an outside diameter in the range of about 2 nm to about 300 nm, or about 50 nm to about 200 nm, depending on the number of walls.

Also suitable for use herein are mixtures of different kinds of carbon filaments wherein the various components of the mixture may differ as to diameter, aspect ratio, shape, extent of layering of graphene sheets, arrangement of graphene sheets, presence or absence of a closed end on the tube formed from a “rolled-up” graphene sheet, and presence or absence of defects and contaminants. Typical defects are graphene edges, which is the edge of a hexagonal ring in a graphene sheet that protrudes from the structure formed from the sheet. This occurs because the ring is not bonded along that edge to an adjacent ring; and the presence in a graphene sheet of pentagonal or heptagonal carbon rings rather than the preferred hexagonal rings. Defect sites are not desired since the filament at that location is more susceptible to thermal oxidation. Typical contaminants are catalyst residue from the manufacturing operation (e.g. iron particles), extraneous, unwanted products obtained from the manufacturing operation (e.g. amorphous carbon), or other contaminants (e.g. “dissolved” iron).

In a preferred embodiment, a carbon filament as used herein will have only traces (less than about 150, less than about 30, 5, 1, 0.5, or less than about 0.1 parts per million by weight) of other elements such as boron, silicon, iron or hydrogen. Preferably, the filaments used herein, and compositions containing them, will have less than 0.5 weight percent of reactive impurities such as ferric sulfide, barium sulfide, calcium sulfide, copper sulfide, barium oxide, calcium oxide, or copper oxide, or compounds of the elements barium, copper, calcium, or the elements iron, barium, copper or calcium.

In the case of iron, it is preferred to have less than about 200 ppm of the element present in the carbon fiber. It is more preferable to have less than about 100, 30, 5, 1, 0.5, or less than about 0.1 parts per million by weight. The same ranges and limits of preferred values hold for the compositions comprising the filaments. Iron appears to be particularly deleterious to the high temperature properties of the composition and its articles, regardless of the source—whether adventitious or specifically catalytic; from the filaments or from other ingredients in the composition.

Various carbon filaments that are suitable for use in a composition hereof include the following:
a vapor grown fine carbon fiber including a hollow space along the fiber in its interior, and having a multi-layer structure, an outer diameter of 2 to 500 nm, and an aspect ratio of 10 to 15,000, which is further described in U.S. Pat. No. 6,730,398, which is by this reference incorporated in its entirety as a part hereof for all purposes;
isolated graphitic polyhedral crystals comprising graphite sheets arranged in a plurality of layers to form an elongated structure having a long axis and a diameter and having 7 or more external facets running substantially the length of the long axis, wherein the diameter is from 5 nm to 1000 nm and the external facets are of substantially equal size, and wherein the crystal may be in the form of a rings, cones, double tipped pyramids, nanorods and whiskers, which is further described in U.S. Pat. No. 6,740,403, which is by this reference incorporated in its entirety as a part hereof for all purposes;
a fine carbon fiber, the main body of each fiber filament of the fiber having an outer diameter of about 1 to about 500 nm and an aspect ratio of about 10 to about 15,000 and comprising a hollow space extending along its center axis and a multi-layer sheath structure consisting of a plurality of carbon layers, the layers forming concentric rings, wherein the fiber filament has a nodular portion which is formed of outwardly protruding carbon layers or formed of a locally increased number of carbon layers; and a similar fine carbon fiber, in which the fiber filament has repeatedly enlarged protruding portions and the filament diameter varies along with the length of the filament, the ratio of the diameter (d″) of a fiber filament of the fiber as measured at the outwardly enlarged portions to the diameter (d) of a fiber filament of the fiber as measured at a position at which no outwardly enlarged portions is present; i.e., d″/d, being about 1.05 to about 3; both of which are further described in U.S. Pat. No. 6,844,061, which is by this reference incorporated in its entirety as a part hereof for all purposes;
a fine carbon fiber mixture produced through a vapor-growth process, which comprises fine carbon fiber, each fiber filament of the fiber having an outer diameter of 1 to 500 nm and an aspect ratio of 10 to 15,000 and comprising a hollow space extending along its center axis and a multi-layer sheath structure consisting of a plurality of carbon layers, which is further described in U.S. Pat. No. 6,974,627, which is by this reference incorporated in its entirety as a part hereof for all purposes;
VGCF® (product of Showa Denko K.K.), average fiber diameter: 150 nm, average fiber length: 9 μm, aspect ratio: 60, BET specific surface area: 13 m²/g, d002=0.339 nm, and Id/Ig=0.2; and VGCF®-S (average fiber diameter: 100 nm, average fiber length: 13 μm, aspect ratio: 130, BET specific surface area: 20 m²/g, d002=0.340 nm, and Id/Ig=0.14), which is further described in U.S. Pat. No. 7,569,161, which is by this reference incorporated in its entirety as a part hereof for all purposes;
multiwall axial carbon filaments having two or more concentric adjacent graphene tubes or have a scrolled, or rolled-up, type structure, wherein the carbon filaments comprise one or more graphite layers, wherein the graphite layers are composed of two or more graphene layers arranged one on top of the other, and the graphite layers form a rolled-up structure, wherein the carbon filaments, in cross-section, exhibit a spiral arrangement of the graphite layers, and wherein the carbon filaments exhibit a mean diameter of from 3 to 100 nm, which is further described in U.S. Patent Publication 2009/0124705, which is by this reference incorporated in its entirety as a part hereof for all purposes; and
scrolls and nested tubes that co-exist within a single multiwall axial carbon nanotube where, in scrolled structures, the layers are oriented essentially parallel to the length axis A, and form an angle with the axis that is typically 0 degrees, or less than at least one of less than 20 degrees, 10 degrees, or 5 degrees; or the length dimension of the tubes or scrolls parallel to the A axis is at least one of 5, 10, 20, 40, 80, 160, or 300 times longer than the outside diameter perpendicular to the A axis, which are further described in S. Iijima, Nature, 354 (1991) 56-58; and “Scrolls and nested tubes in multiwall carbon nanotubes” by J. Gerard Lavina, Shekhar Subramoney, Rodney S. Ruoff, Savas Berber, and David Tománek in Carbon 40 (2002) 1123-1130.

Various other carbon filaments that are suitable for use in a composition hereof include those shown in various figures, which are further described as follows:

FIG. 1: is a computer graphic of a single lampshade graphene structure 10 (a truncated conical tubular graphene layer), and a stack of many such layers along a direction A. The lampshade graphene structure 10 can also be referred to as a bottomless cup. In FIG. 1 the angle of the surface of lampshade graphene structure 10 off the parallel to the axial direction A illustrates an aspect of the orientations of graphene layers in a carbon filament; the distance between single lampshade graphene structures 10 is exaggerated for clarity.

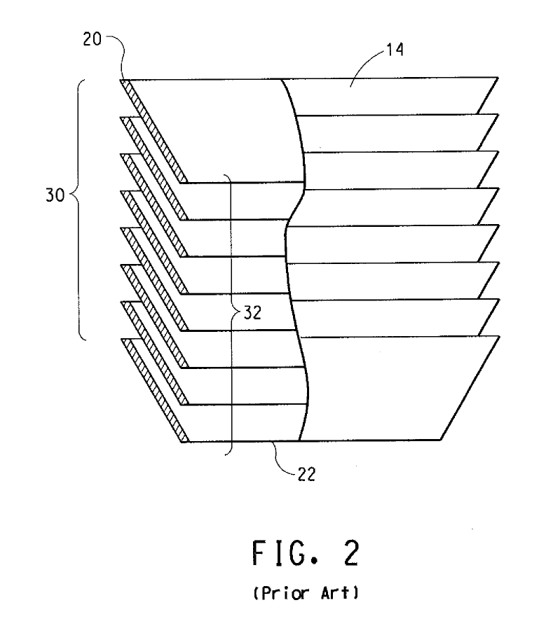

FIG. 2: a schematic view of FIG. 1, showing a stack of eight lampshade graphene structures in partial cutaway, with an outer surface 30 and an inner surface 32. Each lampshade graphene structure has a wide end 20 and a narrow end 22 at opposite ends of the axial direction A of FIG. 1. The cutaway portion of a lampshade graphene structure illustrates an angle of about 45 degrees off the parallel to the axial direction vector A of FIG. 1. The structure has a hollow core 14 formed by the inner surface 32.

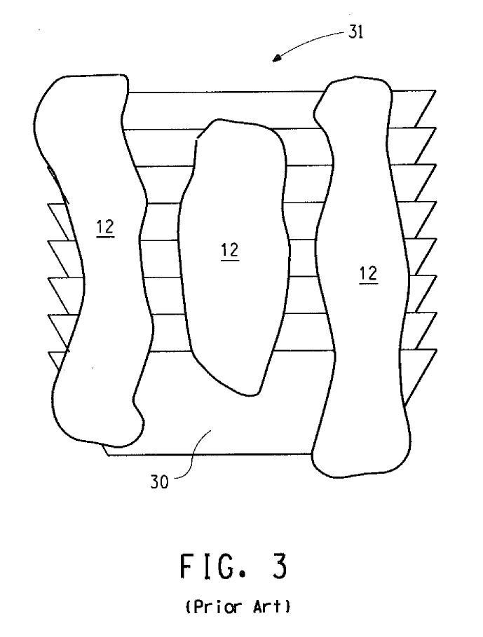

FIG. 3: a portion of a filament 31 having an outer surface 30 of stacked lampshade graphene structure and outer portions of deposited carbonaceous material 12, such as amorphous carbon.

FIG. 4: a portion of a multiwall axial carbon filament with 3 concentric graphene walls (inner wall 11, middle wall 12, and outer wall 13). Multiwall axial carbon filaments have two or more concentric adjacent graphene tubes oriented essentially parallel along the length of the tube.

FIG. 5: a lengthwise cutaway of a multiwall axial carbon filament formed of a single spiraled graphene sheet 15, which is described as having more than two and less than five layers.

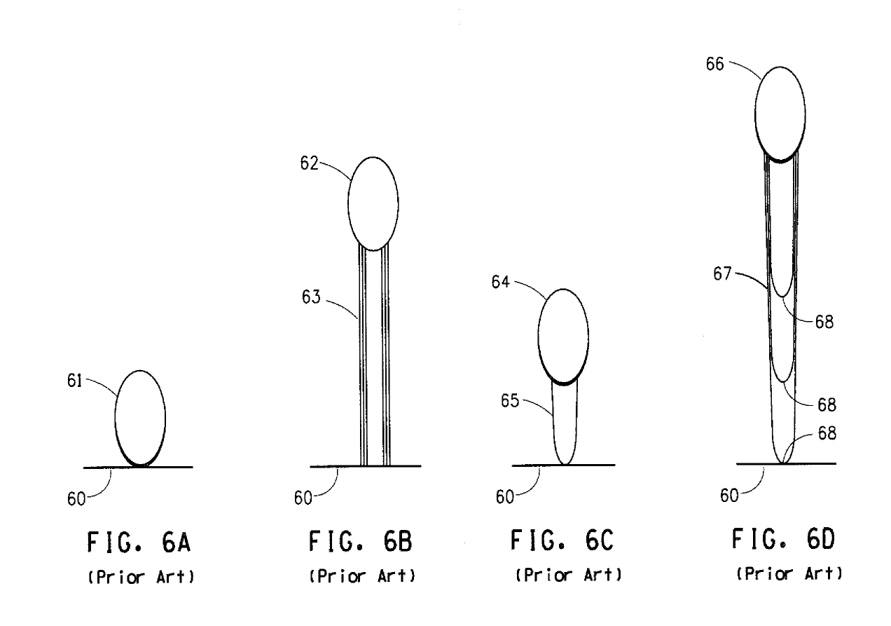

FIG. 6: schematically shows in FIG. 6A an iron catalyst 61 on a substrate 60; in FIG. 6B) graphene growth between the iron particle 62 and the substrate 60 can produce a multiwall axial carbon filament 63 with a terminal iron catalyst; or in FIG. 6C that a single-wall bottom-capped carbon filament 65 with its own terminal iron catalyst 64 may grow from the substrate 60; or in FIG. 6D that a multiwall carbon filament 67 having axial multiwall and perpendicular (90 degree) single wall graphene 68, and its own terminal iron catalyst 66 (the structure of FIG. 6D commonly being called a “bamboo-like” multiwall carbon filament).

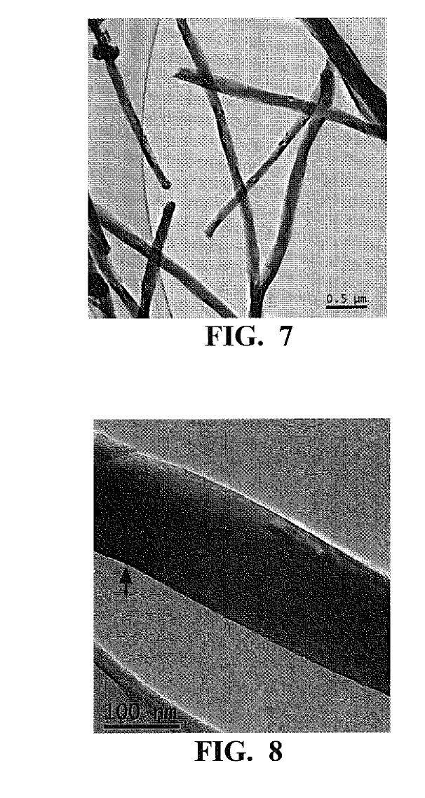

FIGS. 7, 8, and 9 are photomicrographs of a mixture CF-A, a multiwall axial carbon filament, obtained from Showa Denko K.K. (Tokyo, JP). Further features are described in the examples section.

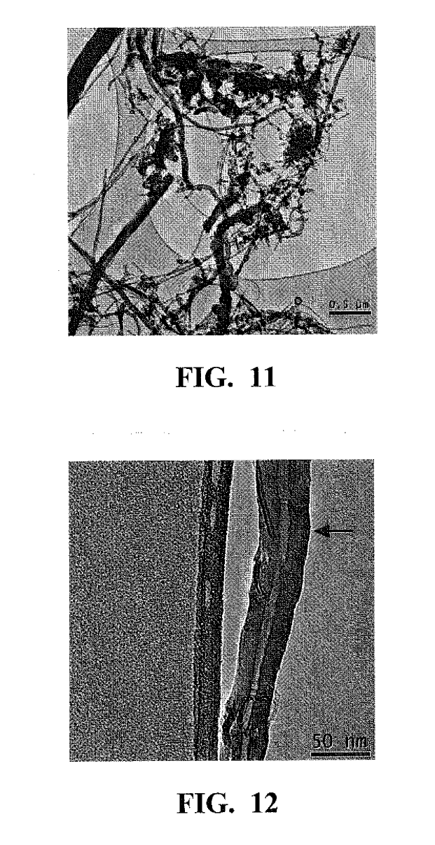

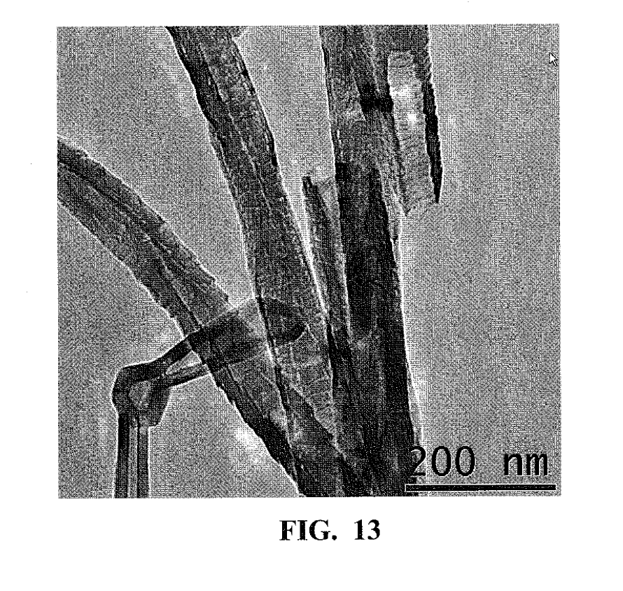

FIGS. 10, 11, and 12 are photomicrographs or a mixture of CF-CN, which was obtained from Nanostructured & Amorphous Materials, Inc. (NanoAmor) (Houston, Tex.). FIG. 10 has an arrow pointing to a particle comprising iron (as confirmed by imagewise energy dispersive spectroscopy). FIG. 11 shows that the fibers present are in a variety of diameters and lengths. FIG. 12 shows a portion of a fiber with a relatively large internal bore free of graphite or graphene. The bore diameter is estimated to be approximately 20% of the filament diameter. Further features are described in the examples section.

FIGS. 13, 14, and 15 are photomicrographs of a mixture CF-CP, which was obtained from Pyrograf Products Inc (Cedarville, Ohio). Iron content of the sample was about 168 ppm as determined by the manufacturer. The isothermal aging test below showed a weight loss of 2.082% for the sample. The filaments were predominantly (>50%) a graphitized carbon nanofiber with diameter of 100 to 200 (˜150) nm, length of 30 to 100 microns, with a surface area of 15-25 (m²/g). Most filaments had an obvious stacked lampshade morphology, often within a multilayer axial carbon filament outer sheath.

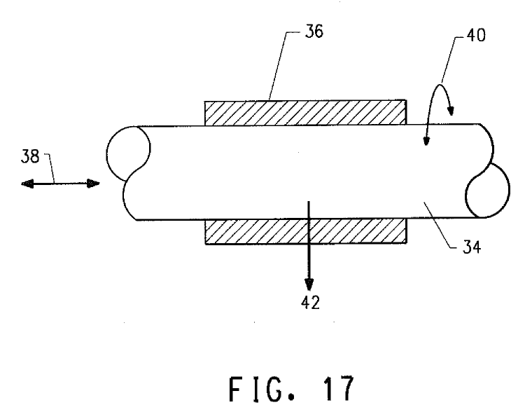

FIG. 16 shows four Raman spectra of the four filament samples. The spectra result from excitation of the filament sample with 785 nm light, and the induced Raman response is recorded. The X axis is labeled as the Raman shift in cm⁻¹ of the emission; the dependent axis is labeled Intensity, in arbitrary units of energy. Major notable Raman bands are obtained at about 1575 cm⁻¹ (G band), and about 1310 cm⁻¹ (D band) for a single analysis. In the spectra shown, the energy units of the G band peak height is normalized to an arbitrary energy unit value of 1; therefore the ratio of Raman D band to G band height ratio at 785 nm excitation is the intensity of the D band.

FIG. 16A shows the spectrum of a commercially available sample CF-CA as described in the Examples section. The Raman D band to G band height ratio at 785 nm excitation was 0.34. FIG. 16B shows the spectrum of a commercially available sample CF-CB as described in the Examples section. The Raman D band to G band height ratio at 785 nm excitation was 0.33. FIG. 16C shows the spectrum of a commercially available sample CF-CN as described in the Examples section. The Raman D band to G band height ratio at 785 nm excitation was 1.05. FIG. 16D shows the spectrum of a commercially available sample CF-CP as described in the Examples section. The Raman D band to G band height ratio at 785 nm excitation was 0.55.

Preferred filament samples have a low ratio of Raman D band as measured by peak height to G band ratio as measured by peak height, both at 785 nm excitation (the “Raman D band to G band height ratio at 785 nm excitation”). More explicitly, preferred filaments have a low Raman D band to G band height ratio at 785 nm excitation, for example less than 1.5, or less than 0.9; more preferably less that 0.45, and even more preferably less than 0.35.

Some carbon filaments are commercially available, such as VGCF®, VGCF®-H, VGCF®-S, and VGCF®-X vapor grown carbon filaments from Showa Denko, KK (Tokyo, Japan) and Pyrograf® III carbon nanofibers from Pyrograf Products, Inc. (Cedarville, Ohio, USA).

Preferred carbon filaments in the mixture of the present invention has a diameter of at least 70 nanometers and not more than 400 nanometers. Multiwall axial carbon filaments used may include large diameter multiwall nanotubes (greater than 50 to less than 1000 nm average outer diameter), and small diameter multiwall nanotubes (greater than 2 to less than 50 nm average outer diameter). In various aspects of the invention, carbon nanofiber is preferred; more preferred is multiwall axial carbon filament. In the compositions and articles disclosed herein carbon filament comprising multiwall angled carbon filament, wherein the ratio of multiwall angled carbon nanotube to said multiwall axial carbon filament is less than 0.2 is preferred.

Certain polymer(s) are preferred for the compositions and articles in the subject environments, for example a high-temperature polymer. A high-temperature polymer includes polyimide, polybenzimidazole, polybenzoxazole, polyamideimide, poly(ether ether ketone) (PEEK), poly(ether ketone) (PEK), poly(ether ketone ketone) (PEKK), polybismaleimide, phenolic, fluoropolymer, epoxy (particularly epoxy-phenolic), or combinations or copolymers thereof. Each high-temperature polymer may comprise any fraction of the total high-temperature polymer; for example less than 0.5% to more than 95% by weight of the high-temperature polymer or any intermediate values.

Typically the polymer forms at least a part of a continuous phase or matrix or filler-surrounding phase, and the filler forms at least a part of a discontinuous phase, although other arrangements are possible.

Certain filler(s) are suitable for compositions and articles disclosed herein for the subject environments, for example a high-temperature filler. A high-temperature filler includes: carbonaceous fillers, which may be graphite, carbon fiber or carbon nanofibers or carbon filament, including or other than carbon filaments as described herein, fiber or nanofiber or filament other than carbon; glass fiber; polymer fiber; alone or in combination. Fillers may also include inorganic materials such as titanium dioxide or molybdenum disulfide.

The amount of polymer used in the composition can be from about 20 weight percent to about 55 weight percent of the total weight of the composition. The amount of filler used in the composition can be from at least about 35 weight percent to about 55 weight percent of the weight of the composition. The amount of carbon filament used in the composition can be from about 0.1 weight percent to about 10 weight percent of a mixture of carbon filaments. Particularly low amounts of carbon filaments may be used in the compositions and articles; for example less than 6%, less than 4%, or even less than 2% by weight of the composition total weight. Further, it is preferred that the composition comprises carbon filament having a diameter of at least 70 nanometers and not more than 400 nanometers, more preferably to be at least 70 nm to 200 nm.

A particular filler that is suitable for use in the compositions of the present invention is graphite. Graphite is typically added to a composition, especially a polyimide composition, to improve one or more of strength, cost, wear or frictional characteristics, or the coefficient of thermal expansion. The amount of graphite used in a polyimide composition for such purpose is thus sometimes advantageously chosen to match the coefficient of thermal expansion of mating components.

Graphite is commercially available in a variety of forms often as a fine powder, and may have a widely varying average particle size for example in the range of from 5 to 75 microns, or the range of from 6 to 25 microns.

Filler or graphite as used herein can be limited to only materials with an aspect ratio of less than 10, preferably less than one of 9, 8, 7, 6, 3, or 2.

Graphite as suitable for use herein can be either naturally occurring graphite or synthetic graphite. Natural graphite generally has a wide range of impurity concentrations, while synthetically produced or modified graphite is commercially available having lowered concentrations of reactive impurities. Graphite containing an unacceptably high concentration of impurities can be purified by any of a variety of known treatments including, for example, chemical treatment with a mineral acid. Treatment of impure graphite with sulfuric, nitric or hydrochloric acid, for example, at elevated or reflux temperatures can be used to reduce impurities to a desired level.

Additives and/or fillers suitable for optional use in a composition or an article hereof may include, without limitation, one or more of the following: pigments; antioxidants; materials to impart a lowered coefficient of thermal expansion; materials to impart high strength properties e.g. glass fibers, ceramic fibers, boron fibers, glass beads, or whiskers; materials to impart heat dissipation or heat resistance properties, e.g. aramid fibers, metal fibers, ceramic fibers or whiskers, silica, silicon carbide, silicon oxide, alumina, magnesium powder or titanium powder; materials to impart corona resistance, e.g. natural mica, synthetic mica or alumina; materials to impart electric conductivity, e.g. carbon black, silver powder, copper powder, aluminum powder or nickel powder; materials to further reduce wear or coefficient of friction, e.g. boron nitride or a fluoroploymer such as poly(tetrafluoroethylene) homopolymer and copolymers. Such additives and/or fillers can also be excluded from the composition or article.

Polymer suitable for the present invention can be a polyimide, for example as described at section 3.30 page 1158 within Pure Appl. Chem., Vol. 81, No. 6, pp. 1131-1186, (2009).

A preferred polymer for use in the composition of the present invention is a polyimide composition, wherein said polyimide has a) an aromatic tetracarboxylic dianhydride component and b) a diamine component comprising: (i) greater than or equal to 60 mole percent to about 85 mole percent p-phenylene diamine; and (ii) 15 mole percent to less than or equal to 40 mole percent m-phenylene diamine; wherein a) and b) are present in a mole ratio of about 1:1 in order to make a condensation polymer of relatively high molecular weight. Such polyimide can be made as described in U.S. Pat. No. 5,886,129 to DeColibus, which is incorporated herein by reference.

A preferred aromatic tetracarboxylic dianhydride component for a polyimide for use in the composition is 3,3′,4,4′-biphenyltetracarboxylic dianhydride (BPDA).

Filler, polymer, filaments, mixtures, and other components described may preferably contain less than 0.5 weight percent of reactive impurities. Preferably, the filler, polymer, filaments and mixtures of the present invention comprise less than 0.5 weight percent of each of ferric sulfide, barium sulfide, calcium sulfide, copper sulfide, barium oxide, calcium oxide, or copper oxide, or compounds of the elements barium, copper, iron, calcium, or the elements iron, barium, copper or calcium.

In the case of iron as an element or in compounds, it is preferred to have less than 0.02% weight as the element present. However, when iron at, below or above 0.02% it is desirable that the iron is encapsulated by carbon, or protected due to the carbon layers around iron particles. Consequently, the iron that is present may not be accessible for oxidation, reaction, or catalysis. It is preferable that the carbon filament itself contains less than 0.02 weight percent iron particles based on the weight of the mixture of carbon filament.

Various aspects (ratios of parts by weight, Raman D band to G band height ratio of filaments, thermal stability of filaments, iron type or content of filaments or compositions, etc.) of the polymer, filler, and carbon filaments described herein can be combined with other components as described herein into instances of the composition of invention for any of the uses of the composition as described herein.

Articles prepared from a composition hereof can be useful in aerospace applications such as aircraft engine parts, such as bushings (e.g., variable stator vane bushings), bearings, washers (e.g., thrust washers), seal rings, gaskets, wear pads, splines, wear strips, bumpers, and slide blocks. These aerospace application parts may be used in all types of aircraft engines such as reciprocating piston engines and, particularly, jet engines. Other examples of aerospace applications include without limitation: turbochargers; shrouds, aircraft subsystems such as thrust reversers, nacelles, flaps systems and valves, and aircraft fasteners; airplane spline couplings used to drive generators, hydraulic pumps, and other equipment; tube clamps for an aircraft engine to attach hydraulic, hot air, and/or electrical lines on the engine housing; control linkage components, door mechanisms, and rocket and satellite components.

Articles prepared from a composition hereof can be useful in transportation applications, for example, as components in vehicles such as but not limited to automobiles, recreational vehicles, off-road vehicles, military vehicles, commercial vehicles, farm and construction equipment and trucks. Examples of vehicular components include without limitation: automotive and other types of internal combustion engines; other vehicular subsystems such as exhaust gas recycle systems and clutch systems; fuel systems (e.g., bushings, seal rings, band springs, valve seats); pumps (e.g., vacuum pump vanes); transmission components (e.g., thrust washers, valve seats, and seal rings such as seal rings in a continuously variable transmission), transaxle components, drive-train components, non-aircraft jet engines; engine belt tensioners; rubbing blocks in ignition distributors; powertrain applications (e.g., emission components), variable valve systems, turbochargers (e.g., ball bearing retainers, wastegate bushings, air induction modules); driveline applications (e.g., seal rings, thrust washers and fork pads in manual and dual clutch transmissions, transfer cases); seal rings and thrust washers for heavy-duty off-road transmissions and hydraulic motors; bushings, buttons, and rollers for continuous variable transmissions in all-terrain vehicles (“ATVs”) and snowmobiles; and chain tensioners for snowmobile gear cases; brake systems (e.g., wear pads, valve components for anti-lock braking systems); door hinge bushings; gear stick rollers; wheel disc nuts, steering systems, air conditioning systems; suspension systems; intake and exhaust systems; piston rings; and shock absorbers.

Articles prepared from a composition hereof can be useful in material handling equipment and materials processing equipment, such as injection molding machines and extrusion equipment (e.g., insulators, seals, bushings and bearings for plastic injection molding and extrusion equipment), conveyors, belt presses and tenter frames; and films, seals, washers, bearings, bushings, gaskets, wear pads, seal rings, slide blocks and push pins, glass handling parts such as clamps and pads, seals in aluminum casting machines, valves (e.g., valve seats, spools), gas compressors (e.g., piston rings, poppets, valve plates, labyrinth seals), hydraulic turbines, metering devices, electric motors (e.g., bushings, washers, thrust plugs), small-motor bushings and bearings for handheld tools appliance motors and fans, torch insulators, and other applications where low wear is desirable.

Articles prepared from a composition hereof can be useful in the manufacture of beverage cans, for example, bushings in body makers that form the can shape, vacuum manifold parts, and shell press bands and plugs; in the steel and aluminum rolling mill industry as bushings and mandrel liners; in gas and oil exploration and refining equipment; and in textile machinery (e.g., bushings for weaving machines, ball cups for knitting looms, wear strips for textile finishing machines).

An article prepared from a composition hereof is suitable for use while in contact with metal, at least part of the time, when an apparatus comprising the article is in normal use.

### EXAMPLES

### Methods

Raman spectra were recorded on each filament sample using a Jobin Yvon Labram HR spectrometer from Horiba Jobin Yvon Inc., Edison. N.J. To carry out the method, samples of the filaments were excited with 785 nm excitation and the induced Raman response was recorded. Major notable Raman bands were obtained at about 1575 cm⁻¹ (G band), and about 1310 cm⁻¹ (D band) for a single analysis; ratios of peak height were calculated from the data.

Dry powder of each composition was fabricated into tensile bars for thermooxidative stability (TOS) test measurements by direct forming according to ASTM E8 (2006), “Standard Tension Test Specimen for Powdered Metal Products-Flat Unmachined Tensile Test Bar”, at room temperature and 690 MPa (100,000 psi) forming pressure. The tensile bars were sintered at 405° C. for 3 hours in a nitrogen atmosphere.

The isothermal aging test for weight loss was carried out at approximately 813 K (1000° F.) by thermogravimetric analysis. A tensile bar sample was heated to 813 K under a nitrogen atmosphere, then replacing the nitrogen atmosphere with an air atmosphere (˜21% oxygen) at a pressure of 5 atmospheres (500 kPa), and holding the sample for 4 hours at 813 K under air, at which time the sample was cooled and the percentage weight loss was determined.

Dry powder was fabricated into wear test specimens for testing by the modified ASTM G133-05 (2005) Wear Rate Method B at 300 cycles/min for 3 hours at 700 K. The specimen disks were 2.5 cm in diameter and about 0.5 cm thick, and produced by direct forming, using a procedure substantially according to the procedure described in U.S. Pat. No. 4,360,626 (note especially column 2, lines 54-60). In these tests, a steel ball bearing was rubbed against the surface of a test specimen disk. At the end of the test, the volume of the resulting wear scar on the test specimen was measured by optical profilometry. The volume of the wear scar is reported as a wear value under these test conditions. Preferred are wear scar volumes under these conditions of less than 5000×10⁻⁷ cm³, preferably less than 4000×10⁻⁷ cm³.

In some instances, relative wear was also determined using a vibratory/oscillatory test method (V/O Test). Referring to FIG. 17, this test method utilizes two specimens: a cylindrical bushing specimen (36, shown in section) and an aircraft engine (turbine type) vane specimen wherein the shaft (34) on the vane rotates in an oscillating manner (40) inside the bushing as the shaft of the vane is concurrently rapidly moved (i.e., vibrated) in an axial manner (38) as depicted in FIG. 17. The specimens move relative to one another in oscillatory rotational (40) and axial (38) movements under a prescribed set of conditions. The load (42) is applied vertically downward through the vane specimen against a horizontally mounted bushing specimen. The radial load, motion stroke length and frequency, test temperature, and test duration are selected such that the test best approximates the load/wear cycle that a bushing would see in an actual jet/turbine engine. Results are reported in terms of wall wear. The hardness and surface finish of the vane are critical in this type of testing, and aircraft engine builders carefully specify these parameters for a particular bushing/vane test. Additionally, aircraft engine builders will specify the following when testing particular vane/bushing combinations: cyclic frequency and magnitude of oscillational and rotational movement, load on the vane shaft, vane diameter, vane material, vane hardness, bushing configuration, clearances between the bushing and vane specimens (i.e., tolerancing), test temperature and method of applying heat (e.g., forced hot air into a test chamber or radiant electric heat or a combination of these).

Materials.

Polyimide Precursors: 3,3′,4,4′-biphenyltetracarboxylic dianhydride was obtained from Mitsubishi Gas Chemical Co., Inc. (Tokyo, Japan). m-Phenylenediamine and p-phenylenediamine were obtained from E.I. du Pont de Nemours and Company (Wilmington, Del., USA).

Polyimide was made as stated below.

Fillers: The graphite used was a synthetic graphite, maximum 0.05% ash, with a median particle size of about 8 microns.

Carbon Filaments:

Carbon Filament CF-A

A sample of carbon filament (sample CF-A) was contained from Showa Denko K.K. (Tokyo, JP). The sample density is approximately 2.1 g/cm³. The sample was reported to have a surface area of approximately 13 (m²/g). Iron content was found to be about 13 ppm by inductively coupled plasma analysis. The isothermal aging test showed a weight loss of 0.882% for the sample. The Raman D band to G band height ratio at 785 nm excitation was 0.34. Photomicrographs of CF-A are FIGS. 7-9.

Filaments of CF-A were predominantly (>50%) a multiwall axial carbon filament typically about 150 nm in diameter, with nearly all less than 350 nm in diameter. The average filament length was about 10-20 microns. Each fiber had a narrow observable hollow bore of about 10 nm, or no observable bore, and the bore if present apparently extended through one narrow end but not both of the fiber (one end appeared capped and the other uncapped). The filament was unbranched. The sample contained polyhedral carbon particles with aspect ratio about 1 and length about 100-300 nm. Apparently less than 15% of other carbon filaments were in the sample as observed by microscopy. Apparently less than 10% of filaments were lampshade filaments as of FIG. 1 or bamboo-like graphene as of FIG. 6D as observed by microscopy.

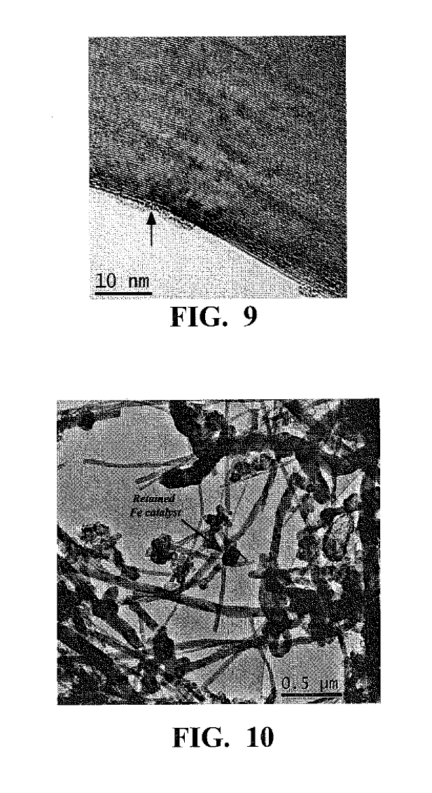

FIG. 7 illustrates features of filament CF-A by transmission electron microscopy. Many of the filaments were noticeably homogeneous in diameter and length. FIG. 8 is an enlargement that also shows the homogenous structure of CF-A; finally FIG. 9 shows a further enlargement where the multiwall axial arrangement of graphene layers was apparent.

Carbon Filament CF-B

A second type of carbon filament (sample CF-B) was obtained from Showa Denko K.K. (Tokyo, JP). Iron content of the sample was about 16 ppm as determined by x-ray fluorescence. The isothermal aging test showed a weight loss of 1.187% for the sample. The Raman D band to G band height ratio at 785 nm excitation was 0.33.

Filaments of CF-B were notably more narrow than the filaments of CF-A, predominantly (>50%) typically about 100 nm (>70 nm) in diameter, and about 10-20 microns in length; otherwise all filaments of the sample were similar to CF-A. The filaments were reported by the manufacturer to have been graphitized at up to about 3070 K.

Carbon Filament CF-CN

Another sample of carbon filament (sample CF-CN) was obtained from Nanostructured & Amorphous Materials Inc. (NanoAmor) (Houston, Tex.). Iron content of the sample was about 73 ppm as determined by the manufacturer. Particles of iron were noted by microscopy as shown in FIG. 10 of sample CF-CN.

FIG. 10 shows a particle of retained iron catalyst. The filaments in the sample CF-CN were not particularly homogeneous. The manufacturer characterized them as graphitized carbon nanofiber about 80-200 nm in diameter and 10-40 microns long. FIG. 11 at a smaller scale further emphasized the inhomogeneity. FIG. 12 shows a filament with an arrow on the right side of the figure; the left side of the figure is an artifact, not a larger filament. In the FIG. 12 a bore was present through most of the fibers, giving the multilayer graphene portion of the fiber an inner diameter about 50% of the filament outer diameter; such structures were common. in CF-CN. Many of the filaments had a bamboo-like structure, but very few had a multilayer lampshade stacking portion.

The isothermal aging test of CF-CN showed a weight loss of 18.21% for the sample. The Raman D band to G band height ratio at 785 nm excitation was 1.05

Carbon Filament CF-CP

Another sample containing carbon filament (CF-CP) was obtained from Pyrograf Products Inc (Cedarville, Ohio). Iron content of the sample was about 168 ppm as determined by the manufacturer. The isothermal aging test showed a weight loss of 2.082% for the sample. The Raman D band to G band height ratio at 785 nm excitation was 0.55.

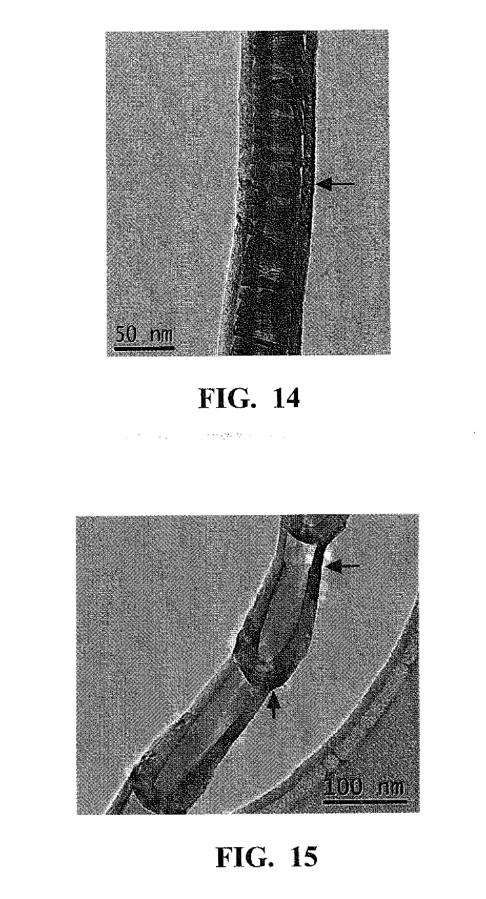

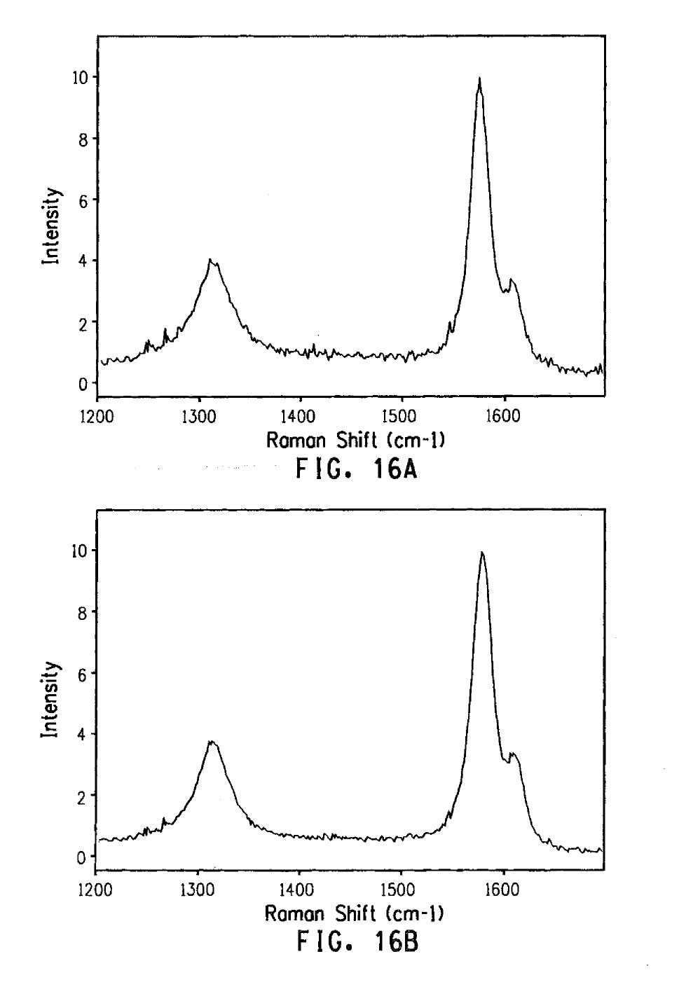

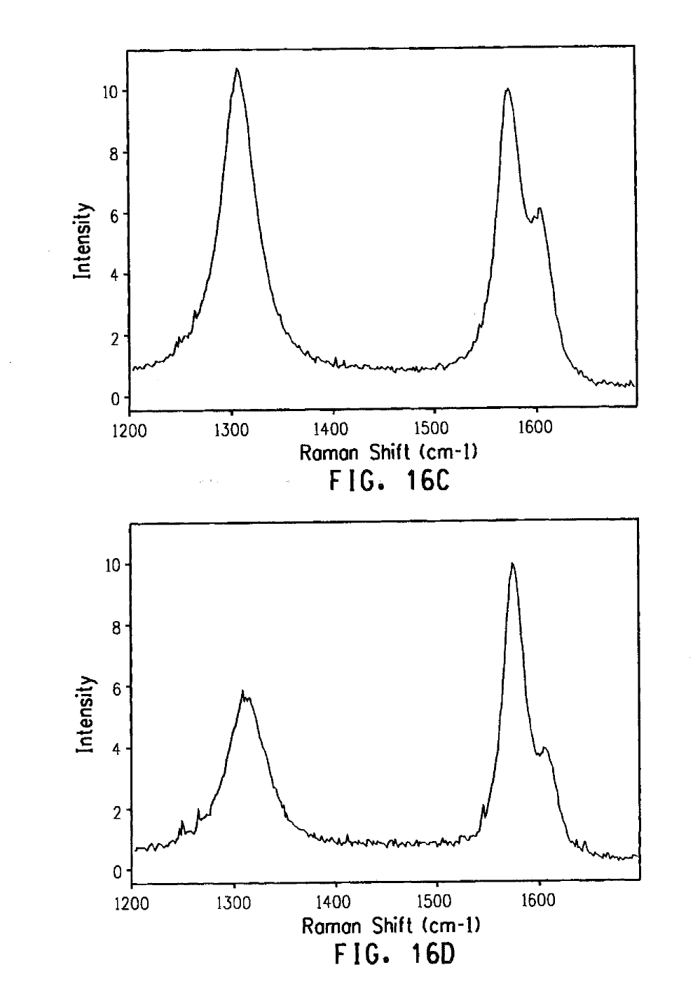

The filaments were predominantly (>50%) a graphitized carbon nanofiber with diameter of 100 to 200 (˜150) nm, length of 30 to 100 microns, with a surface area of 15-25 (m²/g), said to be heated to temperatures up to 3,275 K. FIG. 13 of CF-CP shows that many filaments had an obvious stacked lampshade morphology, often within a multilayer axial outer sheath. FIG. 14 shows such a filament having an outer multiwall axial arrangement of graphene (at the arrow) and an inner core reminiscent of FIG. 1 of stacked cups. FIG. 15 of CF-CP contents shows a “bamboo-like” structure, with the two arrows showing one segment that was repeated in a single filament.

The manufacturer discloses that the filament is produced in the vapor phase by decomposing either methane, ethane, other aliphatic hydrocarbons, or coal gas in the presence of a metal catalyst, hydrogen sulfide and ammonia.

Characteristics of the carbon filaments are summarized in table 1.

TABLE 1

| | CF-A | CF-B | CF-CN | CF-CP |
|---|---|---|---|---|
| Iron, ppm by | 13 | 16 | 73 | 168 |
| weight | | | | |
| Isothermal | 0.882 | 1.187 | 18.21 | 2.082 |
| Weight Loss, | | | | |
| Percent | | | | |
| D Band to | 0.34 | 0.33 | 1.05 | 0.55 |
| G Band Ratio | | | | |

Fluoropolymer Powder Filler

Fluoropolymer ZONYL® MP1300 powder was obtained from E.I. du Pont de Nemours Company, Inc (Wilmington, Del.). The fluoropolymer powder has a melting point of 332° C. (DSC) and a particle size (D50, laser diffraction) of 11 microns.

FIGS. 7-15 are microscopic images that illustrate differences between CF-A, CF-CN, and CF-CP.

FIG. 7 is a transmission electron microscope image of carbon filaments CF-A. The relatively homogeneous thickness and length of the fibers in comparison to later figures is apparent. FIG. 8 shows that the diameter of the typical filament is about 150 nm. FIG. 9 make it apparent that the structure of CF-A is a very orderly multiwall axial filament of many scores of graphene layers; a very small disordered section on the surface is shown by the arrow.

FIG. 10 is a transmission electron microscope image of mixture CF-CN showing carbon filaments and an arrow pointing to an iron particle. FIG. 11 shows that a great variety of types of carbon filaments are found in CF-CN. FIG. 12 shows the structure of one such filament, a narrow (<75 microns) filament with a relatively large hollow core.

FIG. 13 is a transmission electron microscope image of mixture CF-CP. At the lower left, an end portion of a “bamboo-like” filament is apparent. A filament descending from the left side of the frame to the middle bottom of the frame appears to be of the type shown in FIGS. 1 and 2; other filaments appear to be examples of FIG. 3, where the outer portion is a multiwall axial arrangement of graphene layers. FIG. 14 is an enlargement of the latter type of structure; FIG. 15 enlarges a bamboo-like filament.

From these micrograph figures, it is apparent that CF-A has the largest proportion of homogeneous multiwall axial carbon filaments, with minimal amounts “bamboo-like” or stacked lampshade graphene structures.

Raman spectroscopy shows differences between the carbon filament samples. FIG. 16A shows a portion of the Raman spectrum of CF-A; FIG. 16B correspondingly shows the spectrum of CF-B; FIG. 16C correspondingly shows the spectrum of CF-CN, and FIG. 16D correspondingly shows the spectrum of CF-CP. The spectra of CF-A and CF-B are quite similar; but the CF-CN spectrum has a relatively large D band energy emission in ratio to the G band, while the spectrum of CF-CP is intermediate. The ratios found are recorded in Table 1.

### Example 1

Preparation of a Composition and Articles Containing 50 parts [BPDA-alt-MPD]_{0.3}-co-[BPDA-alt-PPD]_{0.7} polyimide, 47 parts Graphite and 3 parts CF-A, in 100 parts total.

Polyimide based on 3,3′,4,4′-biphenyltetracarboxylic dianhydride (BPDA), m-phenylene diamine (MPD) and p-phenylene diamine (PPD) was prepared according to the method described in U.S. Pat. No. 5,886,129, which is by this reference incorporated in its entirety as a part hereof for all purposes. Ingredients were 8.77 g MPD (81.1 mmol), 20.47 g (189 mmol) PPD, and 79.55 g (270 mmol) BPDA. (This polyimide composition is used in all examples including the comparatives.) The BPDA was added to a pyridine solution of the MPD and PPD. The polyamic acid solution produced was imidized in the presence of 41.92 g of graphite and 2.68 g of carbon filament CF-A to produce a polymer containing 50 weight percent polyimide, 47 weight percent graphite and 3.0 weight percent CF-A. The composition was isolated, washed, and dried. After drying, the composition was ground through a 20 mesh screen using a Wiley mill to form a powder.

The powder was fabricated into test specimens, disks 2.5 cm in diameter and about 0.5 cm thick, as described above. The wear rate of the test specimens was determined by modified ASTM G133-05 (2005) Wear Rate Method B at 300 cycles/min for 3 hours at 700 K is given in Table 2, reported as the wear scar volume in units of 10⁻⁷ cm³. Thermooxidative stability (TOS) was measured under 5 atmospheres of air (0.5 MPa) and weight loss after 25 hours at 700 K (800° F., 427° C.) is given in Table 2. This determination is an average of ten replicate compositions.

Experimental results were obtained by the same techniques for each composition of Table 2.

### Example 2

Preparation of a Polyimide Composition and Articles Containing 45 parts polyimide, 50 parts Graphite and 5 parts CF-A.

This composition and article(s) was prepared by the method of Example 1, with the exception that the appropriate ratios of ingredients were used to achieve the 5% CF-A content of the composition, as shown in Table 2 along with experimental results analogous to Example 1. The powder was fabricated into test specimens, disks 2.5 cm in diameter and about 0.5 cm thick, as described above. The wear rate of the test specimens was determined by modified ASTM G133-05 (2005) Wear Rate Method B at 300 cycles/min for 3 hours at 700 K is given in Table 2, reported as the wear scar volume in units of 10⁻⁷ cm³. Thermooxidative stability (TOS) was measured under 5 atmospheres of air (0.5 MPa) and weight loss after 25 hours at 700 K (800° F., 427° C.) is given in Table 2. This determination is an average of nine replicate compositions.

### Example 3

Preparation of a Polyimide Composition and Article(s) Containing 50 parts polyimide, 49 parts Graphite and 1 part CF-B.

This composition and article(s) was prepared by the method of Example 1, except that CF-B carbon filament was used rather than CF-A in the preparation. The wear rate of the resulting article as determined by modified ASTM G133 and the TOS is given in Table 2.

### Example 4

Preparation of a Polyimide Composition and Article(s) Containing 50 parts ([BPDA-alt-MPD]_{0.3}-co-[BPDA-alt-PPD]_{0.7}) polyimide, 48 parts Graphite and 2 parts CF-CP.

This composition and article(s) was prepared by the method of Example 1, except that CF-CP was used rather than CF-A in the preparation. The wear rate of the resulting article as determined by ASTM G133 and the TOS is given in Table 2.

### Example 5

Preparation of a Polyimide Composition and Article(s) Containing 50 parts ([BPDA-alt-MPD]_{0.3}-co-[BPDA-alt-PPD]_{0.7}) polyimide, 47 parts Graphite and 3 parts CF-CN.

This composition and article(s) was prepared by the method of Example 1, except that CF-CN carbon nanofiber was used rather than CF-A in the preparation. The wear rate of the resulting article as determined by ASTM G133 (modified) and the TOS is given in Table 2.

### Examples 6

And Vibratory Test of Relative Wear.

Example 6 was prepared as for Example 1, with a small amount of fluoropolymer powder being added during the graphite addition. The dry powder was prepared as a test specimen for vibratory/oscillatory testing under the same conditions as for Comparative B below.

Comparative A. Preparation of a Polyimide Composition and Article(s) Containing 50 parts ([BPDA-alt-MPD]_{0.3}-co-[BPDA-alt-PPD]_{0.7}) polyimide and 50 parts Graphite.

Polyimide based on 3,3′,4,4′-biphenyltetracarboxylic dianhydride (BPDA), m-phenylene diamine (MPD) and p-phenylene diamine (PPD) was prepared according to the method described in U.S. Pat. No. 5,886,129, which is by this reference incorporated in its entirety as a part hereof for all purposes. Ingredients were 8.77 g MPD (81.1 mmol), 20.47 g (189 mmol) PPD, and 79.55 g (270 mmol) BPDA. The BPDA was added to a pyridine solution of the MPD and PPD. The polyamic acid solution produced was imidized in the presence of 41.92 g of graphite to produce a composition containing 50 weight percent graphite and 50 weight percent polyimide. The composition was isolated, washed, and dried. After drying, the composition was ground through a 20 mesh screen using a Wiley mill to form a powder.

The powder was fabricated into test specimens, disks 2.5 cm in diameter and about 0.5 cm thick, as described above. The wear rate of the test specimens as determined by ASTM G133-05e1 (May 1, 2005) (“ASTM G133”) procedure B, modified as noted (“ASTM G133”) is given in Table 2, reported as the wear scar volume in units of 10⁻⁸ in³ (10⁻⁷ cm³). Thermooxidative stability (TOS) was measured under 5 atmospheres of air (0.5 MPa) and weight loss after 25 hours at 700 K (800° F., 427° C.) is given in Table 2. This determination is an average of ten replicate compositions.

Comparative B was prepared as for Comparative A, with a small amount of fluoropolymer powder being added during the graphite addition. Example 6 and Comparative B were fabricated into cylindrical bushings according to the method described in U.S. Pat. No. 4,360,626, which is by this reference incorporated in its entirety as a part hereof for all purposes. One cylindrical bushing of each example was subjected to the vibratory-oscillatory wear test as described above at 399° C. (750° F.) for 25 hours. Wall wear decrease for Example 6, as the percent improvement versus Comparative Example B, was 25 percent (the ratio of values of wear being 0.75). One cylindrical bushing of each Example 6 and Comparative Example B were subjected to the vibratory wear test as described above at 475° F. (246° C.) for 25 hours. Wall wear improvement for Example 6, as the percent improvement versus Comparative Example B, was 40 percent (the ratio of values being 0.6:1).

Table 2 summarizes the composition and performance of the samples and comparatives.

TABLE 2

| Composition | Comparative A | 1 | 2 | 3 | 4 | 5 | 6 | Comparative B |
|---|---|---|---|---|---|---|---|---|
| Filament Type | None | CF-A | CF-A | CF-B | CF-CN | CF-CP | CF-A | None |
| Filament, parts | 0 | 3 | 5 | 1 | 3 | 2 | 3 | 0 |
| Polyimide, parts | 50 | 50 | 45 | 50 | 50 | 50 | 50 | 50 |
| Graphite, parts | 50 | 47 | 50 | 49 | 47 | 48 | 47 | 50 |
| Fluoropolymer | | | | | | | 0.2 | 0.2 |
| powder, parts | | | | | | | | |
| ASTM G133, | 3858 | 3688 | 3788 | 3202 | 4519 | 5627 | | |
| modified | | | | | | | | |
| (10⁻⁷ cm³) | | | | | | | | |
| TOS, percentage | 2.96 +/− 0.77 | 2.92 +/− 0.61 | 2.64 +/− 0.40 | 2.05 | 4.68 | 2.28 | | |
| weight loss +/− | (14) | (10) | (9) | (1) | (1) | (1) | | |
| standard | | | | | | | | |
| deviation | | | | | | | | |
| (# of samples) | | | | | | | | |
| V/O Test, 246° C. | | | | | | | 0.6 | 1 |
| V/O Test, 399° C. | | | | | | | 0.75 | 1 |

All percentages used in compositions are by percentages by weight of the total composition unless otherwise specified. All parts used in compositions are parts by weight of the total composition unless otherwise specified.

What is claimed is:

1. A composition comprising (a) from about 20 weight percent to about 55 weight percent of high-temperature polymer; and (b) from about 35 weight percent to about 55 weight percent of high-temperature filler; and (c) from about 0.1 weight percent to about 10 weight percent of a mixture of carbon filament, wherein said mixture of carbon filament comprises multiwall axial carbon filament; and
wherein the total of weight percent of said composition equals 100.

2. The composition of claim 1, wherein the high temperature filler comprises 50 to 100 weight percent graphite based on the weight of high temperature filler.

3. The composition of claim 1, wherein the mixture of carbon filament has a Raman D band to G band height ratio at 785 nm excitation of less than 0.9.

4. The composition of claim 3, wherein said ratio is less than 0.45.

5. The composition of claim 1 wherein said mixture of carbon filament contains less than 100 ppm iron based on the weight of said mixture of carbon filament, or is based on the weight of said composition.

6. The composition of claim 1, wherein said composition contains less than 30 ppm iron based on the weight of said composition.

7. The composition of claim 1 wherein said high-temperature polymer comprises at least one or more selected from the group consisting of polyimide polymer, polybenzimidazole, polybenzoxazole, bismaleimide, polyamideimide, poly(ether ether ketone), poly(ether ketone), poly(ether ketone ketone), poly(bismaleimide), phenolic, fluoropolymer, and epoxy (particularly epoxy-phenolic) polymer.

8. The composition of claim 7 wherein said high temperature polymer comprises a polyimide, wherein said polyimide has
a) an aromatic tetracarboxylic dianhydride component and
b) a diamine component comprising:
(i) greater than 60 mole percent to about 85 mole percent p-phenylene diamine; and
(ii) 15 mole percent to less than 40 mole percent m-phenylene diamine;
wherein a) and b) are present in a ratio of about 1:1.

9. The composition of claim 8 wherein said aromatic tetracarboxylic dianhydride component is 3,3′,4,4′-biphenyltetracarboxylic dianhydride.

10. The composition of claim 3, wherein said composition comprises carbon filament having a length of more than 2 microns and less than 20 microns.

11. The composition of claim 3, wherein said composition comprises carbon filament having a width of more than 70 nanometers and less than 400 nanometers.

12. The composition of claim 1, wherein said composition comprises carbon filament having a hollow bore, said bore having a diameter less than 0.4 times the diameter of said carbon filament having the bore.

13. An article made from the composition of claim 1.

14. The article of claim 13, said article having modified ASTM G133-05 (2005) Wear Rate Method B at 300 cycles/min for 3 hours at 700 K of less than 5000×10⁻⁷ cm³.

15. The article of claim 13, said article having modified ASTM G133-05 (2005) Wear Rate Method B at 300 cycles/min for 3 hours at 700 K of less than 4000×10⁻⁷ cm³.

16. The article of claim 13, wherein the article is a bushing.

17. The article of claim 13, wherein said article is suitable for use in low wear applications.
